(19) United States
(12) Patent Application Publication
(10) Pub. No.: US 2009/0072437 A1
(43) Pub. Date: Mar. 19, 2009

(54) HIGH SPEED CASTING OF A GOLF BALL LAYER

(76) Inventor: William Brum, Raynham, MA (US)

Correspondence Address: ACUSHNET COMPANY, 333 BRIDGE STREET, P. O. BOX 965, FAIRHAVEN, MA, 02719, US

(21) Appl. No.: 11/856,136

(22) Filed: Sep. 17, 2007

(51) Int. Cl. B29C 69/02

(52) U.S. Cl. 264/241

(57) ABSTRACT

A method of casting a cover layer about a golf ball core utilizing a single cavity mold that moves on a continuous conveyor, and the cover layers are cast without any “stop and go” or batch methods being involved. The continuous motion conveyor system is a closed loop system that provides for the automatic pre-heating of top and bottom mold halves and the depositing of a core into the bottom mold halve after a layer material such as urethane has been dispensed into the molds by an articulating module comprising of a plurality of dispensing nozzles. The nozzles translate in a tangential motion with the moving conveyor and dispense the cover material without any stoppage of the conveyor line. The method then assembles the mold halves into a single cavity mold without the use of bolts, but only employing clamping pins that use spring force for compression, and releasable retainers to lock the mold for the curing stage, and then unlocking he mold for the disassembling and product removal.

### FIELD OF THE INVENTION

The invention relates to golf balls. More particularly, the invention relates to a high speed method for casting an intermediate layer or cover over a golf ball core.

### BACKGROUND OF THE INVENTION

Regardless of the form of the ball, players generally seek a golf ball construction that has particular play characteristics of velocity and spin, which match their swing style and club preference. It is well know in the golf ball industry that both initial ball velocity and spin have both been determined to be substantially dependent on the compression of the core and the quality of the cover layers.

Throughout its history, the golf ball has undergone an extensive evolution in an effort to improve its play-related characteristics, e.g., durability, distance, and control. Modern day golf balls can be classified as one-piece, two-piece, and three-piece (also known as “wound”) balls. One-piece balls are formed from a homogeneous mass of material with a dimple pattern molded therein. One-piece balls are inexpensive and very durable, but do not provide great distance because of relatively high spin and low velocity. Two-piece balls are the most popular types of ball in use today. They are made by molding a cover around a solid core. Three and four-piece balls are made by molding a cover about a core that has one or more intermediate layers about it. The cores typically measure from 1.4 to 1.6 inches (3.5 to 4.1 cm) in diameter. The cover, which may include one or more cover layers, is molded about the core to form a golf ball having the minimum United States Golf Association (USGA) specified diameter of 1.68 inches (4.3 cm). Typically, the cover has a thickness of about 0.04 inches (0.1 cm). Two-piece balls typically have a hard “cutproof” cover which gives a longer distance ball, but which has lower spin rates, resulting in a decreased ability to control the ball.

Golf balls are typically manufactured by various molding processes, whether one-component or multi-component balls. The cover is then formed over the core and intermediate boundary layers, if present, through such methods as casting, compression molding, and/or injection molding.

The cover is typically made from any number of thermoplastic or thermosetting materials, including thermoplastic resins such as ionomeric, polyester, polyetherester or polyetheramide resins; thermoplastic or thermoset polyurethanes or polyureas; natural or synthetic rubbers, such as balata (natural or synthetic) or polybutadiene; or some combination of the above.

Polyurethanes have also been recognized as useful materials for golf ball covers since about 1960. The resulting golf balls are durable, while at the same time maintaining the “feel” of a balata ball. The first commercially successful polyurethane covered golf ball was the Titleist Professional ball, first released in 1993. Subsequently, the Titleist Pro-V1 ball was introduced successfully in 2000 with a solid resilient polybutadiene core, a hard ionomer casing and a polyurethane cover. The Pro-V1 ball provided both professional and amateur players with long distance off of drivers and control for greenside play. Polyureas have also been proposed as cover materials for golf balls. For instance, a polyurea composition comprising the reaction product of an organic diisocyanate and an organic amine, each having at least two functional groups, is known.

Conventionally, castable aromatic polyurethane elastomers have been molded using molds that are preheated between 140° F. to 180° F. and cores that are preheated between 100° F. and 140° F. Such preheating is thought to facilitate a reasonable gel time to allow cores to be centered into the castable material and the cover to be molded over the cores. Golf balls molded from preheated cores also help to reduce seam failures at the time of de-molding because of reduced core expansion rate of the preheated cores during molding.

Present day casting processes utilize pairs of mold cavities. In the casting process, a cover material, typically fluid thermoset polyurethane, is introduced into a first mold cavity of each pair. Then, a core is held in position (e.g. by an overhanging vacuum or suction apparatus) to contact the cover material in what will be the spherical center of the mold cavity pair. Once the cover material is at least partially cured (e.g., a point where the core will not substantially move), the core is released, the cover material is introduced into a second mold cavity of each pair, and the mold is closed. The closed mold is then subjected to heat and pressure to cure the cover material thereby forming a cover on the core. The mold cavities typically include a dimple pattern to impart a dimples on the cover during the molding process.

A major problem, whether the ball is produced by casting, compression molding, injection molding, or reaction injection molding (“RIM”), is that the processes all involve a batch type manufacturing layout, wherein urethane material components and cased cores are distributed to distinct casting locations. This involves a stoppage and downtime for the introduction of materials into the mold, and in processes involving multiple cavities in a single frame, more problems are encountered. Currently, mold closure is accomplished via vertical pistons, torque clutch/motor assembly, and an assembly of belts, pulleys and torque bits. For four cavity molds there is a need for four bolts to fasten mold halves together. This process is reversed during the disassembly process. Significant torque variation is present due to the nature of dry assembly and mechanical wear. These assembly/disassembly machinery modules are a root cause of parting line thickness variation and a major source of surface contamination on the golf ball.

There is a need to place cover layers about cores more efficiently, conserving energy costs, increasing production speeds, reducing space requirements, improving quality control, reducing ergonomic issues, and generally making a better golf ball at a lower cost. The present invention provides for utilizing a single cavity mold and an articulating dispensing assembly module that uses multiple discharge nozzles to obtain a more accurate material discharge into the mold cavity and operating in a continuous motion in an assembly line fashion. Urethane material components and cased core equipment modules area positioned at the “point of use” on the assembly line thus reducing labor and allowing total automation on a continuous conveyor.

### SUMMARY OF THE INVENTION

The present invention is directed to a method of casting a cover layer about a golf ball core on a continuous conveyor, wherein the product components are delivered automatically on an assembly line basis, and the covers are cast without any “stop and go” or batch methods being involved. The continuous motion conveyor system is a closed loop system that provides for the pre-heating of top and bottom mold halves prior to a layer material such as urethane being dispensed into conveyor moving molds, and subsequently the depositing of a core into the molds. The system then assembles the mold halves into a single cavity mold without the use of bolts, but only employing clamping pins that use spring force for compression, and releasable retainers to lock the mold for the curing stage, and then unlocking he mold for the disassembling and product removal.

According to one embodiment of the invention, the cover material is dispensed into the mold halves by an articulating nozzle arrangement, wherein the nozzles travel in tangent with the mold as it moves along the conveyor. There is no stop and fill or any slowdown as experienced with a batch process. Each nozzle is equipped with its own mixing chamber and the material is fed from the chamber directly through the articulating nozzle as it moves tangently with the mold half. The speed of the nozzle is coordinated to the speed of the conveyor to provide for the dispensing of the proper amount of material. The amount of the shot of material can be varied depending on the desired thickness of the cover layer.

An embodiment of the invention is directed to a method of casting an intermediate layer about a golf ball core on a continuous conveyor, wherein the product components are delivered automatically on an assembly line basis, but the mold halves do not have reversed dimple patterns on the inside surfaces.

### BRIEF DESCRIPTION OF THE DRAWINGS

FIG. 1 is a top plan view of a schematic of the high speed casting assembly line according to the invention.

FIG. 2 is a front view of a schematic of four mixing chambers and nozzles making up the articulating dispensing module.

FIG. 3 is a top view of a schematic illustrating the motion profile of the nozzles of FIG. 2.

FIG. 4 is a front elevational view of a single cavity mold.

FIG. 5 is a side elevational view of the single cavity mold thereof.

FIG. 6 is a top plan view of the single cavity mold thereof.

FIG. 7 is a cross-section side view taken along line A-A of FIG. 4.

FIG. 8 is a cross-section side view of the top mold half backing plate taken along line A-A of FIG. 4 FIG. 9 is a cross-section front view taken along line B-B of FIG. 4.

FIG. 10 is a top plan view of the lower backing plate including the two slidable retainers.

FIG. 11 is a front elevation view of the lower backing plate of the invention.

FIG. 12 is a pictorial top view of one of the retainers.

### DETAILED DESCRIPTION OF THE PREFERRED EMBODIMENT

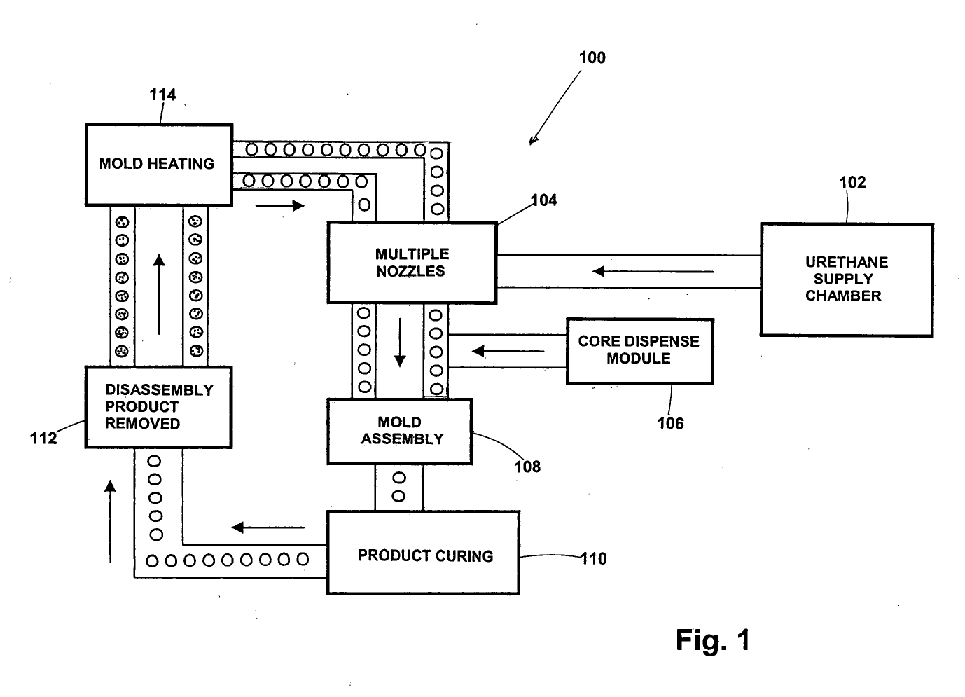

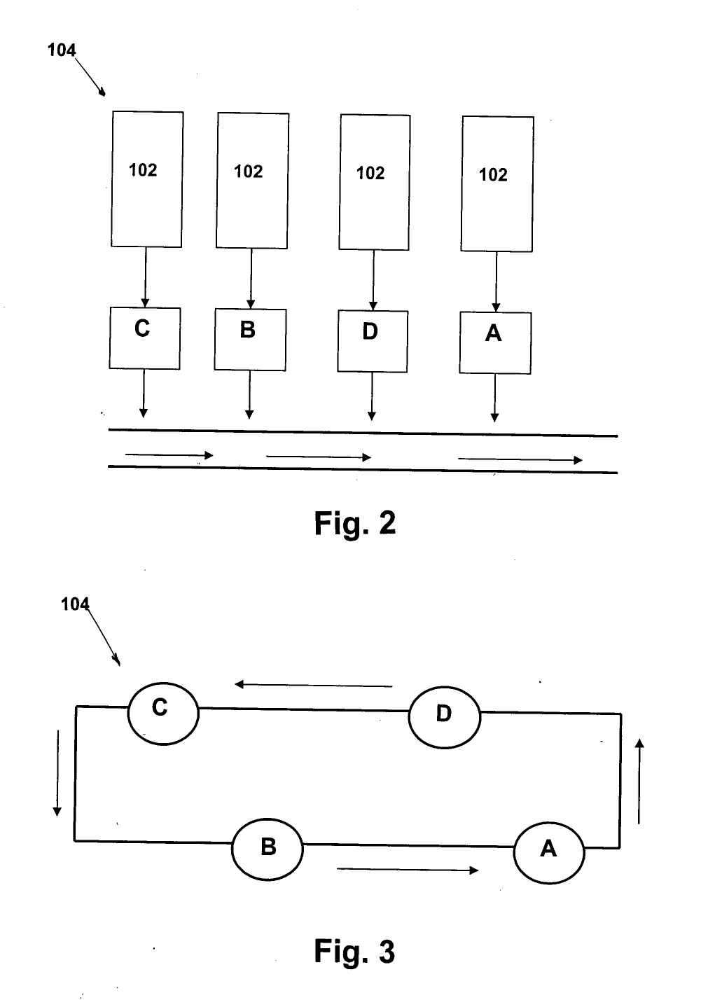

As shown in FIGS. 1-3, the present invention provides for a method for casting materials such as polyurethane into single cavity molds 20 which are moving along a continuous motion conveyor, to produce a layer or cover about a golf ball core. The method employs a continuous motion dispensing unit having multiple mixing chambers 102 and nozzles A, B, C, and D, that transfer urethane type materials from the mixing chambers directly into the top and bottom mold halves 20a and 20b, as the molds move along the conveyor. Since the nozzles leading from he chambers A, B, C, and D are articulating and move tangently with the mold cups along the conveyor line, there is no stoppage at any time. The material cast to form the intermediate layers or cover layers is provided at a more accurate discharge dose than any multiple batch cavity method, and more importantly operates in a continuous motion with no stoppage. The single discharge nozzles are mounted on an articulating dispensing assembly module. As a single cavity mold passes on the conveyor system, the mixing chamber/nozzle synchronizes with the x-axis motion and articulates along the y-axis as it dispenses into the cavity of the mold. Once the dispense cycle is complete the module returns to its home position. This motion is repeated in a continuous fashion as shown in FIGS. 2-3.

The inventive concept utilizes a single cavity mold concept, which is disclosed in co-pending U.S. application Ser. No. 11/678,787, the disclosure of which is hereby expressly incorporated herein by express reference thereto. The single cavity molds are delivered to the dispensing module in an assembly line fashion. As stated above, the continuous motion conveyors are synchronized with the dispensing module as multiple cavities are filled as they pass. Urethane material components and cased core equipment modules are positioned at the “point of use” on the assembly line thus reducing labor and automation required to deliver product for assembly. High speed assembly and disassembly modules are reduced to vertical and horizontal motion. Mold assembly, product cure, and disassembly occur in a closed loop allowing for automated delivery of molds to the dispensing station in a continuous fashion.

The cover material in the form of pre-polymer and curative streams are metered and mixed in chambers 102. The material stream is then delivered through the nozzle arrangement which accepts the mixed material from the chamber and allows discharge through the nozzle. The balance of the material discharge through multiple nozzles is a source of process variation. The process variation can result in golf ball cover thickness variation, voids, etc. Single nozzle discharge provides a more accurate shot size. The present day process systems require stop and go motion which adds to overall production time. The continuous motion concept affords the opportunity to utilize reduced cavity concepts which will yield higher quality products while maintaining high volume production.

Present methods cast urethane material components into multiple cores encased in a frame in a “batch type” manufacturing layout. The material components and the cased cores must be distributed to distinct casting locations. This distributed layout creates a high labor content, which the present invention promotes significant levels of complexity in the form of automation to reduce labor. The “point of use” application of the assembly line concept will reduce the labor content as golf ball components reside adjacent to the conveyor line. Automation and material handling is minimized as bulk handling is required to meet line capacity. Line speeds of the present invention operate at 100 balls per minute.

The single cavity molds, as described in the co-pending '787 application eliminate bolts in the closure of the molds, which eliminates a major source of golf ball contamination from thread wear. The single cavity nozzle discharge not only provides a more accurate shot size, but a more efficient molding operation over multiple cavity molds. The cavity registration is improved as linear distance from dowel pins to cavity center is reduced. Having only one cavity mold instead of multiple cavities allows for a more even force pattern from pin/retainer design and generates consistent unit pressure at the cavity parting line (about 600 psi).

For the present invention, the single cavity molds 20 include a dimple pattern for the interior surface of the mold as in the “787 application when casting a cover layer. Upon the material being dispensed into the mold halves 20a and 20b, and then a core deposited therein, they are then transported to an assembly station 108, wherein the top mold halves 20a are clamped onto the loaded bottom mold halves 20b to create a single cavity mold 20. The single cavity mold 20 compresses the core and layer into a spherical core shape by utilizing spring force and retainer plates to exert about 384 lbs of force. The assembled single cavity molds 20 then travel on the conveyor through a product curing station 110 wherein the cure is completed at a temperature of about 150° F. Upon completion of the cure, the molds 20 travel to a disassembly station 112 upon which the mold halves 20a, 20b are therein separated, product is robotically removed and flash removed all in the automated fashion. The mold halves 20a and 20b then travel to a preheated staging station 114, wherein they are heated to about 200° F.

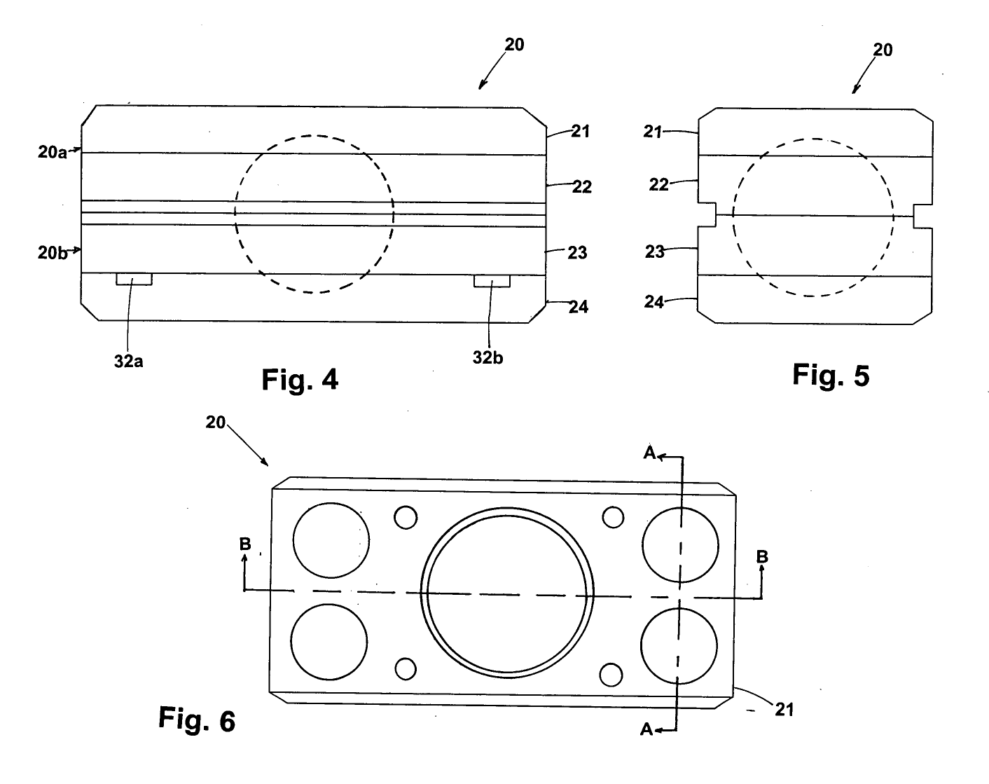

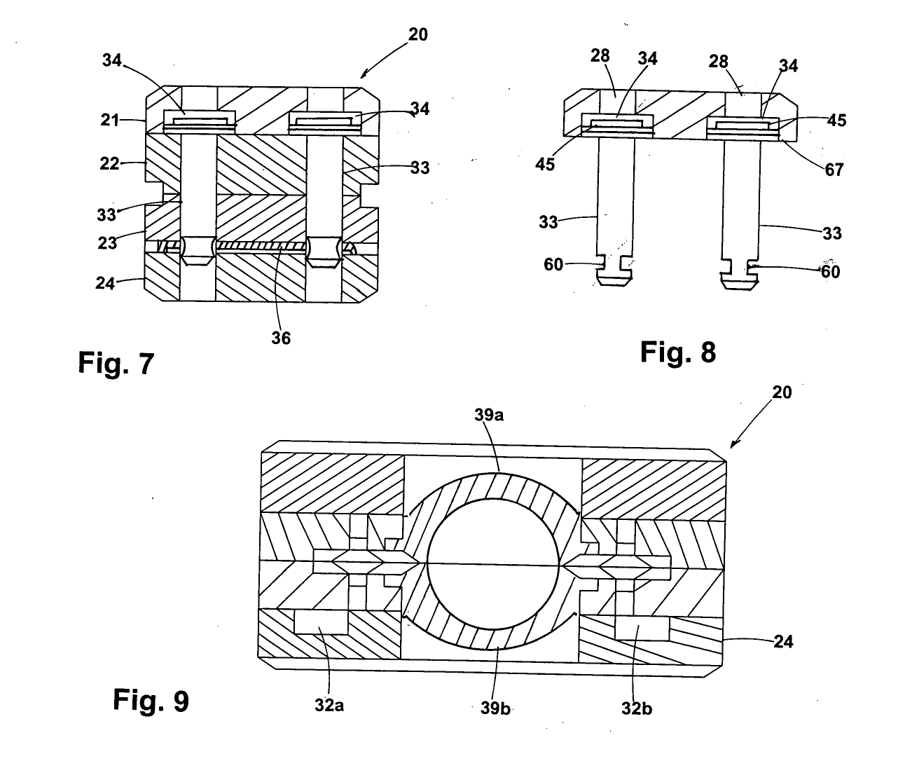

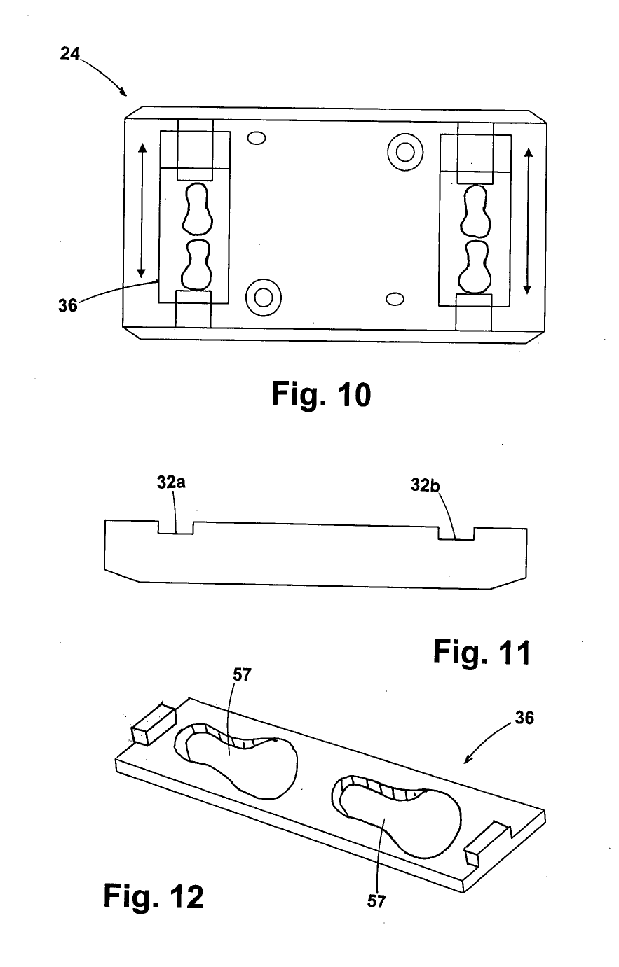

As described in FIGS. 3-12, the single cavity mold 20 comprises a pair of mold halves, a top 20a and a bottom 20b, with each mold half having backing plates 21 and 24, and mold frames 22 and 23 respectively. The top mold half houses an upper hemispherical cavity mold 39a while the bottom mold half houses a lower hemispherical cavity 39b. Each mold provides for compression molding using only the single cavity and without the need of bolts to secure the mold halves together. The mold 20 utilizes a plurality of clamping pins 33, each pin having its top portion reciprocally disposed in a recess 34 of the backing plate 21 of the top mold 20a. Double spring Belleville washers 45 are integral to the top portion of each clamping pin 33 and when an outside force is applied, the washers 45 are compressed placing the device into a controlled state of tension. To maintain the compressive force for the duration of the molding cycle, the clamping pins 33, which have cutout sections 60 in the lower area, are locked in the tension state by a pair of sliding retainers 36 that are positioned in channels 32a and 32b of the lower backing plate 24. Each retainer 36 comprises a pair of engagement loops 57 of a size and shape for locking with the cutout sections 60 of the pins 33. When an outside source on the conveyor provides a horizontal force to the retainers 36, the engagement loops 57 of the retainers slide freely within the channels 32a and 32b and into contact with the cutout sections 60 of the clamping pins 33 which have been lowered into position by the vertical force upon them, wherein the clamping pins 33 are locked in a tensioned state for the duration of the molding cycle. To release the mold-halves, a subsequent vertical force is applied to the top of the clamping pins 33 wherein they are moved out of the locking relationship with the engagement loops 57, and with a coordinating horizontal force applied, the retainers 36 are moved away from the pins 33, releasing the compressive force on the mold halves 20a and 20b. Not only are bolts eliminated, but also any subsequent uneven forces applied throughout the mold. The uneven application of force is a main cause of uneven thickness of cover material, especially in the application of polyurethane material.

During the assembling and disassembling of the mold halves 20a and 20b, alignment pins, a diamond shaped pin 42 and a round pin 43, facilitate the quick connection and disconnection of the mold halves. The mold halves are combined without any mechanical tools. When the mold halves are assembled a force is applied to the mold causing Belleville washers 45 on the top portion of clamping pins 33 to compress the layer about the core and with the application of heat, the layer is cured. Upon completion of the layer being cured, the compressive force is released, wherein the mold is opened and the ball removed. The compressive force is held in place such that a minimum force of 384 lbs is attained and held. To open the mold a vertical force on the Belleville washers is applied by means on the conveyor, and then a horizontal force is applied to slide the retainers out from the locked position. The mold is opened and the ball is removed to the next process step.

The composition and method of manufacture for golf balls of this invention are further directed to solid cores used in two, three or four piece golf balls. In one embodiment, the golf ball core composition of the present invention comprises a blend of a first, resilient, thermoset rubber material, preferably polybutadiene, a second, reinforcing, thermoset rubber material, preferably trans-polyisoprene and a modified, non-ionic polyolefin compatible with the thermoset rubber materials, preferably a copolymer of ethylene and an alkyl acrylate. The composition comprises from about 50% to about 99%, preferably from about 60% to about 90%, and more preferably from about 70% to about 85% of the first resilient thermoset rubber material; about 1 to about 40%, preferably about 10% to about 30%, and more preferably from about 15% to about 25% of the second reinforcing thermoset rubber material; and about 0.5% to about 10%, preferably about 1% to about 5%, and more preferably, about 1.5% to about 3.5% of a compatible modified, non-ionic polyolefin.

Resilient polymers suitable for use in the golf ball core formed according to this invention include polybutadiene, polyisoprene, styrene-butadiene, styrene-propylene-diene rubber (EPDM), mixtures thereof, and the like. The resilient polymer component is preferably polyisoprene or polybutadiene (“PBD”), more preferably polybutadiene, and most preferably a 1,4-cis-polybutadiene. One example of a 1,4-cis-polybutadiene is CARIFLEX BR 1220, commercially available from H. MUEHLSTEIN & CO., INC. of Norwalk, Conn. The polybutadiene or other resilient polymer component may be produced with any suitable catalyst that results in a predominantly 1,4-cis content, and preferably with a catalyst that provides a high 1,4-cis content and a high molecular weight average. The resilient polymer component has a high molecular weight average, defined as being at least about 50,000 to 1,000,000, preferably from about 250,000 to 750,000, and more preferably from about 200,000 to 325,000. CARIFLEX BR 1220 has a molecular weight average of about 220,000. The 1,4-cis component of polybutadiene is generally the predominant portion of the resilient polymer component when polybutadiene is present. “Predominant” or “predominantly” is used herein to mean greater than 50 weight percent. The 1,4-cis component is preferably greater than about 90 weight percent, and more preferably greater than about 95 weight percent, of the polybutadiene component.

Suitable cross linking agents for use in the ball core in accordance with the invention, include one or more metallic salts of unsaturated fatty acids or monocarboxylic acids, such as zinc, calcium, or magnesium acrylate salts, and the like. Preferred acrylates include zinc acrylate, zinc diacrylate, and zinc methacrylate. Most preferably, zinc diacrylate (“ZDA”) is selected as the cross linking agent. The cross linking agent must be present in an amount sufficient to cross-link the various chains of polymers in the polymer blend to themselves and to each other. The cross linking agent is generally present in the center in an amount from greater than about 10 phr to about 24 phr, preferably from about 12 phr to about 24 phr, and more preferably from about 15 phr to about 24 phr. As used herein when referring to the ball center, “phr” means parts per hundred based on the amount of the polymer blend. The desired elastic modulus for the mantle may be obtained by adjusting the amount of cross linking. This may be achieved, for example, by altering the type and amount of cross linking agent, which method is well known to those of ordinary skill in the art.

Suitable cover materials include, but are not limited to: (1) Polyurethanes, such as those prepared from polyols and diisocyanates or polyisocyanates and those disclosed in U.S. Pat. Nos. 5,334,673 and 6,506,851 and U.S. patent application Ser. No. 10/194,059; (2) Polyureas, such as those disclosed in U.S. Pat. No. 5,484,870 and U.S. patent application Ser. No. 10/228,311; and (3) Polyurethane-urea hybrids, blends or copolymers comprising urethane or urea segments.

The cover layer preferably includes a polyurethane composition comprising the reaction product of at least one polyisocyanate and at least one curing agent. The curing agent can include, for example, one or more diamines, one or more polyols, or a combination thereof. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent.

In yet another embodiment, the polyurethane composition includes at least one isocyanate, at least one polyol, and at least one curing agent. Exemplary polyisocyanates include, but are not limited to, 4,4′-diphenylmethane diisocyanate (“MDI”), polymeric MDI, carbodimide-modified liquid MDI, 4,4′-dicyclohexylmethane diisocyanate (“H.sub.12MDI”), p-phenylene diisocyanate (“PPDI”), toluene diisocyanate (“TDI”), 3,3′-dimethyl-4,4′-biphenylene diisocyanate (“TODI”), isophoronediisocyanate (“IPDI”), hexamethylene diisocyanate (“HDI”), naphthalene diisocyanate (“NDI”); xylene diisocyanate (“XDI”); para-tetramethylxylene diisocyanate (“p-TMXDI”); meta-tetramethylxylene diisocyanate (“m-TMXDI”); ethylene diisocyanate; propylene-1,2-diisocyanate; tetramethylene-1,4-diisocyanate; cyclohexyl diisocyanate; 1,6-hexamethylene-diisocyanate (“HDI”); dodecane-1,12-diisocyanate; cyclobutane-1,3-diisocyanate; cyclohexane-1,3-diisocyanate; cyclo-hexane-1,4-diisocyanate; 1-isocyanato-3,3,5-trimethyl-5-isocyanatomethylcyclo-hexane; methyl cyclohexylene diisocyanate; triisocyanate of HDI; triisocyanate of 2,4,4-trimethyl-1,6-hexane diisocyanate (“TMDI”), tetracene diisocyanate, naphthalene diisocyanate, anthracene diisocyanate, and mixtures thereof. Polyisocyanates are known to those of ordinary skill in the art as having more than one isocyanate group, e.g., di-, tri, and tetra-isocyanate. Preferably, the polyisocyanate includes MDI, PPDI, TDI, or a mixture thereof, and more preferably, the polyisocyanate includes MDI. It should be understood that, as used herein, the term “MDI” includes 4,4′-diphenylmethane diisocyanate, polymeric MDI, carbodiimide-modified liquid MDI, and mixtures thereof and, additionally, that the diisocyanate employed may be “low free monomer,” understood by one of ordinary skill in the art to have lower levels of “free” monomer isocyanate groups than conventional diisocyanates, i.e., the compositions of the invention typically have less than about 0.1% free monomer groups. Examples of “low free monomer” diisocyanates include, but are not limited to Low Free Monomer MDI, Low Free Monomer TDI, and Low Free Monomer PPDI.

Suitable polyisocyanates should have less than about 14% unreacted NCO groups. Preferably, polyisocyanates should have no greater than about 7.5% NCO, more preferably, from about 2.5% to about 7.5%, and most preferably, from about 4% to about 6.5%.

The polyol component of the polyurethane can be polyester polyols. Suitable polyester polyols include, but are not limited to, polyethylene adipate glycol, polybutylene adipate glycol, polyethylene propylene adipate glycol, ortho-phthalate-1,6-hexanediol, and mixtures thereof. The hydrocarbon chain can have saturated or unsaturated bonds, or substituted or unsubstituted aromatic and cyclic groups.

Alternatively, the polyol component can be polycaprolactone polyols. Suitable polycaprolactone polyols include, but are not limited to, 1,6-hexanediol-initiated polycaprolactone, diethylene glycol initiated polycaprolactone, trimethylol propane initiated polycaprolactone, neopentyl glycol initiated polycaprolactone, 1,4-butanediol-initiated polycaprolactone, and mixtures thereof. The hydrocarbon chain can have saturated or unsaturated bonds, or substituted or unsubstituted aromatic and cyclic groups.

Alternatively, the polyol component can be polycarbonate polyols. Suitable polycarbonates include, but are not limited to, polyphthalate carbonate. The hydrocarbon chain can have saturated or unsaturated bonds, or substituted or unsubstituted aromatic and cyclic groups.

The curing agent may include a polyol curing agent. Suitable polyol curing agents include, but are not limited to, ethylene glycol, diethylene glycol, polyethylene glycol, polyethylene propylene glycol, polypropylene glycol, lower molecular weight polytetramethylene ether glycol, 1,3-bis(2-hydroxyethoxy) benzene, 1,3-bis-[2-(2-hydroxyethoxy)ethoxy]benzene, 1,3-bis-{2-[2-(2-hydroxyethoxy)ethoxy]ethoxy}-benzene, 1,4-butanediol, 1,5-pentanediol, 1,6-hexanediol, resorcinol-di-(beta-hydroxyethyl) ether, hydroquinone-di-(.beta.-hydroxyethyl) ether, trimethylol propane, or mixtures thereof.

Polyamine curatives are also suitable for use in the curing agent of the polyurethane composition and have been found to improve cut, shear, and impact resistance of the resultant balls. Preferred polyamine curatives include, but are not limited to, 3,5-dimethylthio-2,4-toluenediamine and isomers thereof; 3,5-diethyltoluene-2,4-diamine and isomers thereof, such as 3,5-diethyltoluene-2,6-diamine; 4,4′-bis-(sec-butylamino)-diphenylmethane; 1,4-bis-(sec-butylamino)-benzene; 4,4′-methylene-bis-(2-chloroaniline); 4,4′-methylene-bis-(3-chloro-2,6-diethylaniline); polytetramethyleneoxide-di-p-aminobenzoate; N,N′-dialkyldiamino diphenyl methane; p,p′-methylene dianiline (“MDA”); m-phenylenediamine (“MPDA”); 4,4′-methylene-bis-(2-chloroaniline) (“MOCA”); 4,4′-methylene-bis-(2,6-diethylaniline); 4,4′-diamino-3,3′-diethyl-5,5′-dimethyl diphenylmethane; 2,2′,3,3′-tetrachloro diamino diphenylmethane; 4,4′-methylene-bis-(3-chloro-2,6-diethylaniline); trimethylene glycol di-p-aminobenzoate; and mixtures thereof. Preferably, the curing agent of the present invention includes 3,5-dimethylthio-2,4-toluenediamine and isomers thereof, such as ETHACURE 300. Suitable polyamine curatives, which include both primary and secondary amines, preferably have weight average molecular weights ranging from about 64 to about 2000.

Additionally, at least one of a diol, triol, tetraol, or hydroxy-terminated curative may be added to the aforementioned polyurethane composition. Suitable diol, triol, and tetraol groups include ethylene glycol; diethylene glycol; polyethylene glycol; propylene glycol; polypropylene glycol; lower molecular weight polytetramethylene ether glycol; 1,3-bis(2-hydroxyethoxy) benzene; 1,3-bis-[2-(2-hydroxyethoxy)-ethoxy]benzene; 1,3-bis-{2-[2-(2-hydroxyethoxy)ethoxy]ethoxy}benzene; 1,4-butanediol; 1,5-pentanediol; 1,6-hexanediol; resorcinol-di-(4-hydroxyethyl) ether; hydroquinone-di-(4-hydroxyethyl) ether; and mixtures thereof. Preferred hydroxy-terminated curatives include ethylene glycol; diethylene glycol; 1,4-butanediol; 1,5-pentanediol; 1,6-hexanediol, trimethylol propane, and mixtures thereof.

Preferably, the hydroxy-terminated curatives have molecular weights ranging from about 48 to 2000. Both the hydroxy-terminated and amine curatives can include one or more saturated, unsaturated, aromatic, and cyclic groups. Additionally, the hydroxy-terminated and amine curatives can include one or more halogen groups. The polyurethane composition can be formed with a blend or mixture of curing agents or with a single curing agent.

An optional filler component may be chosen to impart additional density to blends of the previously described components. The selection of the filler component is dependent upon the characteristics of the golf ball desired. Examples of fillers for use in the filler component of the polyurethane include those described herein. Similar or identical additives, such as nanoparticles, fibers, glass spheres, and/or various metals, such as titanium and tungsten, can be added to the polyurethane compositions of the present invention, as well, in amounts as needed to modify one or more golf ball properties. Additional components that can be added to the polyurethane composition include UV stabilizers and other dyes, as well as optical brighteners and fluorescent pigments and dyes. Such additional ingredients may be added in any amounts that will achieve their desired purpose.

Any known method may be used to combine the polyisocyanate, polyol, and curing agent of the present invention. One suitable method, known in the art as a one-shot method, involves concurrent mixing of the polyisocyanate, polyol, and curing agent. A preferred method of mixing is known as a prepolymer method. In this method, the polyisocyanate and the polyol are mixed separately prior to addition of the curing agent. This method affords a more homogeneous mixture resulting in a more consistent polymer composition.

Due to the very thin nature, the use of a castable, reactive material applied in a fluid form makes it possible to obtain very thin outer cover layers on golf balls. Specifically, castable, reactive liquids, which react to form a urethane elastomer material, provide desirable very thin outer cover layers. The castable, reactive liquid employed to form the urethane elastomer material can be applied by the nozzles A, B, C, or D.

The outer cover layer should have a material hardness, as measured by ASTM D2240-00, from about 20 to about 60 Shore D, preferably from about 30 to about 50 Shore D, more preferably about 45 Shore D. When the hardness of the outer cover material is measured directly on the golf ball, the values tend to be higher than then the material hardness. The outer cover hardness, as measured on the golf ball, is preferably from about 45 to about 60 Shore D. If an inner is molded over the core, it preferably has a material hardness of about 50 to about 70 Shore D, more preferably from about 60 to about 65 Shore D.

As stated above, the core can be made from either (a) thermosetting material such as polybutadiene, ZDA, peroxide and a cis-to-trans catalyst, or (b) thermoplastic material such as highly neutralized polymer that is fully neutralized, whereby the core has a diameter at least about 1.55 inches, a compression of less than about 85, and a COR greater than about 0.815.

If the core is made from thermosetting material, the core composition preferably includes at least one rubber material having a resilience index of at least about 40. Preferably, the resilience index is at least about 50. A comparison of a number of polybutadiene polymers are listed in Table 1 below. Polymers that produce resilient golf balls and, therefore, are suitable for use in the center or other portions of a golf ball according to the present invention include, but are not limited to, CB23, CB22, BR60, and 1207G.

The thermosetting material in the core comprises a reaction product that includes a cis-to-trans catalyst, a resilient polymer component having polybutadiene, a free radical source, and optionally, a crosslinking agent, a filler, or both. Preferably, the polybutadiene reaction product is used to form at least a portion of the core of the golf ball, and further discussion below relates to this embodiment for preparing the core. Preferably, the reaction product has a first dynamic stiffness measured at −50° C. that is less than about 130 percent of a second dynamic stiffness measured at 0° C. More preferably, the first dynamic stiffness is less than about 125 percent of the second dynamic stiffness. Most preferably, the first dynamic stiffness is less than about 110 percent of the second dynamic stiffness.

The cis-to-trans conversion requires the presence of a cis-to-trans catalyst, such as an organosulfur or metal-containing organosulfur compound, a substituted or unsubstituted aromatic organic compound that does not contain sulfur or metal, an inorganic sulfide compound, an aromatic organometallic compound, or mixtures thereof. The cis-to-trans catalyst component may include one or more of the cis-to-trans catalysts described herein. For example, the cis-to-trans catalyst may be a blend of an organosulfur component and an inorganic sulfide component.

The preferred organosulfur components include 4,4′-diphenyl disulfide, 4,4′-ditolyl disulfide, or 2,2′-benzamido diphenyl disulfide, or a mixture thereof. A more preferred organosulfur component includes 4,4′-ditolyl disulfide. The organosulfur cis-to-trans catalyst, when present, is preferably present in an amount sufficient to produce the reaction product so as to contain at least about 12 percent trans-polybutadiene isomer, but typically is greater than about 32 percent trans-polybutadiene isomer based on the total resilient polymer component. In another embodiment, metal-containing organosulfur components can be used according to the invention. Suitable metal-containing organosulfur components include, but are not limited to, cadmium, copper, lead, and tellurium analogs of diethyldithio-carbamate, diamyldithiocarbamate, and dimethyldithiocarbamate, or mixtures thereof. Additional suitable examples of can be found in commonly owned and co-pending U.S. patent application Ser. No. 10/402,592.

The cis-to-trans catalyst or organosulfur compound, preferably halogenated, is compound having cis-to-trans catalytic activity or a sulfur atom (or both), and is resent in the polymeric composition by at least about 0.01 phr, preferably at least bout 0.05 phr, more preferably at least about 0.1 phr, even more preferably greater han about 0.25 phr, optionally greater than about 2 phr, such as greater than about 2.2 phr, or even greater than about 2.5 phr, but no more than about 10 phr, preferably less than about 5 phr, more preferably less than about 2 phr, even more preferably less than about 1.1 phr, such as less than about 0.75 phr, or even less than about 0.6 phr. Useful compounds of this category include those disclosed in U.S. Pat. Nos. 6,525,141, 6,465,578, 6,184,301, 6,139,447, 5,697,856, 5,816,944, and 5,252,652, the disclosures of which are incorporated by reference in their entirety.

One group of suitable organosulfur compounds are halogenated thiophenols and metallic compounds thereof, which are exemplified by pentafluorothiophenol, 2-fluorothiophenol, 3-fluorothiophenol, 4-fluorothiophenol, 2,3-fluorothiophenol, 2,4-fluorothiophenol, 3,4-fluorothiophenol, 3,5-fluorothiophenol 2,3,4-fluorothiophenol, 3,4,5-fluorothiophenol, 2,3,4,5-tetrafluorothiophenol, 2,3,5,6-tetrafluorothiophenol, 4-chlorotetrafluorothiophenol, pentachlorothiophenol, 2-chlorothiophenol, 3-chlorothiophenol, 4-chlorothiophenol, 2,3-chlorothiophenol, 2,4-chlorothiophenol, 3,4-chlorothiophenol, 3,5-chlorothiophenol, 2,3,4-chlorothiophenol, 3,4,5-chlorothiophenol, 2,3,4,5-tetrachlorothiophenol, 2,3,5,6-tetrachlorothiophenol, pentabromothiophenol, 2-bromothiophenol, 3-bromothiophenol, 4-bromothiophenol, 2,3-bromothiophenol, 2,4-bromothiophenol, 3,4-bromothiophenol, 3,5-bromothiophenol, 2,3,4-bromothiophenol, 3,4,5-bromothiophenol, 2,3,4,5-tetrabromothiophenol, 2,3,5,6-tetrabromothiophenol, pentaiodothiophenol, 2-iodothiophenol, 3-iodothiophenol, 4-iodothiophenol, 2,3-iodothiophenol, 2,4-iodothiophenol, 3,4-iodothiophenol, 3,5-iodothiophenol, 2,3,4-iodothiophenol, 3,4,5-iodothiophenol, 2,3,4,5-tetraiodothiophenol, 2,3,5,6-tetraiodothiophenol and, the metal salts thereof, and mixtures thereof. The metal ions, when present, are associated with the thiophenols, and are chosen from zinc, calcium, magnesium, cobalt, nickel, iron, copper, sodium, potassium, and lithium, among others. Halogenated thiophenols associated with organic cations such as ammonium are also useful for the present invention.

More specifically, workable halogenated thiophenols include pentachlorothio-phenol, zinc pentachlorothiophenol, magnesium pentachlorothiophenol, cobalt pentachlorothiophenol, pentafluorothiophenol, zinc pentafluorothiophenol, and blends thereof. Preferred candidates are pentachlorothiophenol (available from Strucktol Company of Stow, Ohio), zinc pentachlorothiophenol (available from eChinachem of San Francisco, Calif.), and blends thereof.

Another group of suitable organosulfur compounds are organic disulfides which include, without limitation, perhalogenated (i.e., fully halogenated) organic disulfides and organometallic disulfides. Perhalogenated compounds are preferably perfluorinated, perchlorinated, and/or perbrominated. Perhalogenated organic disulfides include perhalogenated derivatives of any and all organic disulfides known and/or available to one skilled in the art, which include those disclosed herein, such as ditolyl disulfides, diphenyl disulfides, quinolyl disulfides, benzoyl disulfides, and bis(4-acryloxybenzene)disulfide, among others. A particular example is perchloroditolyl disulfide. Organometallic disulfides include combinations of any metal cations disclosed herein with any organic disulfides disclosed herein. A particular example is zinc ditolyl disulfide.

Suitable substituted or unsubstituted aromatic organic components that do not include sulfur or a metal include, but are not limited to, 4,4′-diphenyl acetylene, azobenzene, or a mixture thereof. The aromatic organic group preferably ranges in size from C.sub.6 to C.sub.20, and more preferably from C.sub.6 to C.sub.10. Suitable inorganic sulfide components include, but are not limited to titanium sulfide, manganese sulfide, and sulfide analogs of iron, calcium, cobalt, molybdenum, tungsten, copper, selenium, yttrium, zinc, tin, and bismuth.

The cis-to-trans catalyst can also include a Group VIA component. Elemental sulfur and polymeric sulfur are commercially available from, e.g., Elastochem, Inc. of Chardon, Ohio. Exemplary sulfur catalyst compounds include PB(RM-S)-80 elemental sulfur and PB(CRST)-65 polymeric sulfur, each of which is available from Elastochem, Inc. An exemplary tellurium catalyst under the tradename TELLOY and an exemplary selenium catalyst under the tradename VANDEX are each commercially available from RT Vanderbilt.

A free-radical source, often alternatively referred to as a free-radical initiator, is required in the composition and method. The free-radical source is typically a peroxide, and preferably an organic peroxide. Suitable free-radical sources include di-t-amyl peroxide, di(2-t-butyl-peroxyisopropyl)benzene peroxide, 3,3,5-trimethyl cyclohexane, a-a bis(t-butylperoxy) diisopropylbenzene, 1,1-bis(t-butylperoxy)-3,3,5-trimethylcyclohexane, dicumyl peroxide, di-t-butyl peroxide, 2,5-di-(t-butylperoxy)-2,5-dimethyl hexane, n-butyl-4,4-bis(t-butylperoxy)valerate, lauryl peroxide, benzoyl peroxide, t-butyl hydroperoxide, and the like, and any mixture thereof.

A crosslinking agent is included to increase the hardness of the reaction product. Suitable crosslinking agents include one or more metallic salts of unsaturated fatty acids or monocarboxylic acids, such as zinc, aluminum, sodium, lithium, nickel, calcium, or magnesium acrylate salts, and the like, and mixtures thereof. Preferred acrylates include zinc acrylate, zinc diacrylate (ZDA), zinc methacrylate, and zinc dimethacrylate (ZDMA), and mixtures thereof. The crosslinking agent must be present in an amount sufficient to crosslink a portion of the chains of polymers in the resilient polymer component. For example, the desired compression may be obtained by adjusting the amount of cross-linking. This may be achieved, for example, by altering the type and amount of cross-linking agent, a method well-known to those of ordinary skill in the art.

The compositions of the present invention may also include fillers, added to the polybutadiene material to adjust the density and/or specific gravity of the core or to the cover. Fillers are typically polymeric or mineral particles. Exemplary fillers include precipitated hydrated silica, clay, talc, asbestos, glass fibers, aramid fibers, mica, calcium metasilicate, barium sulfate, zinc sulfide, lithopone, silicates, silicon carbide, diatomaceous earth, polyvinyl chloride, carbonates such as calcium carbonate and magnesium carbonate, metals such as titanium, tungsten, aluminum, bismuth, nickel, molybdenum, iron, lead, copper, boron, cobalt, beryllium, zinc, and tin, metal alloys such as steel, brass, bronze, boron carbide whiskers, and tungsten carbide whiskers, metal oxides such as zinc oxide, iron oxide, aluminum oxide, titanium oxide, magnesium oxide, and zirconium oxide, particulate carbonaceous materials such as graphite, carbon black, cotton flock, natural bitumen, cellulose flock, and leather fiber, micro balloons such as glass and ceramic, fly ash, and combinations thereof.

Antioxidants may also optionally be included in the polybutadiene material in the centers produced according to the present invention. Antioxidants are compounds that can inhibit or prevent the oxidative degradation of the polybutadiene. Antioxidants useful in the present invention include, but are not limited to, dihydroquinoline antioxidants, amine type antioxidants, and phenolic type antioxidants.

Other optional ingredients, such as accelerators, e.g., tetramethylthiuram, peptizers, processing aids, processing oils, plasticizers, dyes and pigments, as well as other additives well known to those of ordinary skill in the art may also be used in the present invention in amounts sufficient to achieve the purpose for which they are typically used.

The compression of the core, or portion of the core, of golf balls prepared according to the invention is typically from about 15 to 100. In one embodiment, the compression is below about 50, more preferably below about 25. In a preferred embodiment, the compression is from about 60 to 90, more preferably from about 70 to 85. Various equivalent methods of measuring compression exist. For example, a 70 Atti compression (also previously referred to as the “PGA Compression”) is equivalent to a center hardness of 3.2 mm deflection under a 100 kg load and a “spring constant” of 36 Kgf/mm. In one embodiment, the golf ball core has a deflection of about 3.3 mm to 7 mm under a 130 kg-10 kg test.

Alternatively, the core of the present invention is thermoplastic, comprising essentially a highly neutralized polymer (“HNP”) that is formed from a reaction between an acid group on the polymer and a suitable source of cation that comprises an organic acid or the corresponding salt. The organic acid or salt thereof being present is in an amount sufficient to neutralize the polymer by at least about 80%. In a preferred embodiment, the polymer may be neutralized by about 90%. In another preferred embodiment, the polymer may be neutralized by about 100%.

The HNP's comprises ionomeric copolymers, ionomeric terpolymers, ionomer precursors, thermoplastics, thermoplastic elastomers, grafted metallocene-catalyzed polymers, non-grafted metallocene-catalyzed polymers, single-site polymers, highly crystalline acid polymers and ionomers thereof, cationic ionomers and mixtures thereof.

Examples of organic acid of the HNP include, but are not limited to, an aliphatic organic acid, an aromatic organic acid, a saturated mono-functional organic acid, a saturated di-functional organic acid, a saturated multi-functional organic acid, an unsaturated mono-functional organic acid, an unsaturated di-functional organic acid, an unsaturated multi-functional organic acid, and a multi-unsaturated mono-functional organic acid.

Suitable cations can be used to neutralize the organic acids of the HNP. Examples of suitable cations include, but are not limited to, barium, lithium, sodium, zinc, bismuth, chromium, cobalt, copper, potassium, strontium, titanium, tungsten, magnesium, cesium, iron, nickel, silver, aluminum, tin, or calcium.

Alternatively, salts of fatty acids can be used to neutralize the organic acids of the HNP. These fatty acids include, but are not limited to, caprioic acid, caprylic acid, capric acid, lauric acid, stearic acid, behenic acid, erucic acid, oleic acid, linoelic acid, or dimerized derivatives thereof.

Exemplary HPN thermoplastic ionomer resins are obtained by providing a cross metallic bond to polymers of monoolefin with at least one member selected from the group consisting of unsaturated mono- or di-carboxylic acids having 3 to 12 carbon atoms and esters thereof. The polymer contains 1 to 50% by weight of the unsaturated mono- or di-carboxylic acid and/or ester thereof. More particularly, low modulus ionomers, such as acid-containing ethylene copolymer ionomers, include E/X/Y copolymers where E is ethylene, X is acrylic or methacrylic acid present in 5-35 (preferably 10-35, most preferably 15-35, making the ionomer a high acid ionomer) weight percent of the polymer, and Y is a softening co-monomer such as acrylate or methacrylate present in 0-50 (preferably 0-25, most preferably 0-2), weight percent of the polymer, wherein the acid moiety is neutralized 1-100% (preferably at least 80%, most preferably about 100%) to form an ionomer by a cation such as lithium, sodium, potassium, magnesium, calcium, barium, lead, tin, zinc or aluminum, or a combination of such cations. In another embodiment, lithium, sodium, potassium, magnesium, calcium and zinc are the preferred cations in these HNP.

Examples of HNP that are suitable for this invention are specific acid-containing ethylene copolymers, including ethylene/acrylic acid, ethylene/methacrylic acid, ethylene/acrylic acid/n-butyl acrylate, ethylene/methacrylic acid/n-butyl acrylate, ethylene/methacrylic acid/methyl acrylate, ethylene/methacrylic acid/methyl acrylate, ethylene/methacrylic acid/methyl methacrylate, and ethylene/acrylic acid/n-butyl methacrylate. Preferred acid-containing ethylene copolymers include ethylene/methacrylic acid, ethylene/acrylic acid, ethylene/methacrylic acid/n-butyl acrylate, ethylene/acrylic acid/n-butyl acrylate, ethylene/methacrylic acid/methyl acrylate and ethylene/acrylic acid/methyl acrylate copolymers. The most preferred acid-containing ethylene copolymers are ethylene/methacrylic acid, ethylene/acrylic acid, ethylene/(meth)acrylic acid/n-butyl acrylate, ethylene/(meth)acrylic acid/ethyl acrylate, and ethylene/(meth)acrylic acid/methyl acrylate copolymers.

Additional HNP ionomers suitable for use in this invention are described in WO 00/23519, WO 01/29129, and in commonly-owned and copending U.S. patent application Ser. Nos. 10/877,344 and 10/882,130. All the references herein mentioned are incorporated by reference in their entireties.

Optionally, filler component is chosen to impart additional density to blends of the previously described components, the selection being dependent upon the different parts (e.g., cover, mantle, core, center, intermediate layers in a multilayered core or ball) and the type of golf ball desired (e.g., one-piece, two-piece, three-piece or multiple-piece ball), as will be more fully detailed below. Generally, the filler will be inorganic having a density greater than about 4 grams/cubic centimeter (gm/cc), preferably greater than 5 gm/cc, and will be present in amounts between 0 to about 60 wt. % based on the total weight of the composition. Examples of useful fillers include those described herein. It is preferred that the filler materials be non-reactive or almost non-reactive and not stiffen or raise the compression nor reduce the coefficient of restitution significantly.

Additionally, other additives useful in the practice of the subject invention include acid copolymer wax (e.g., Allied wax AC 143 believed to be an ethylene/16-18% acrylic acid copolymer with a number average molecular weight of 2,040), which assist in preventing reaction between the filler materials (e.g., ZnO) and the acid moiety in the ethylene copolymer. Other optional additives include TiO.sub.2, which is used as a whitening agent, optical brighteners, surfactants, processing aids, etc.

It will be understood that the claims are intended to cover all changes and modifications of the preferred embodiments of the invention, herein chosen for the purpose of illustration, which do not constitute a departure from the spirit and scope of the invention.

What is claimed is:

1. A method of casting a cover layer about a golf ball core, comprising the steps of:
providing a continuous motion conveyor system having a plurality of top and bottom single cavity mold halves, in continuous motion on the conveyor;
providing an articulating dispensing module comprised of multiple mixing chambers, each chamber having a dispensing nozzle;
pre-heating the mold halves;
dispensing metered shots of cover material into the mold cavities while the mold halves continually are in motion and each dispensing nozzle moves in tangent with one of the mold halves;
depositing by automatic robotic means cores into bottom mold halves;
assembling mold halves together to form a single cavity mold containing the core and cover layer;
compressing the cover material about the core by utilizing spring force and retainer plates to form a spherical golf ball;
curing the covered ball; and
disassembling the mold and automatically removing the covered ball.

2. The method of claim 1, wherein the pre-heating temperature of the mold halves is about 200° F.

3. The method of claim 1, wherein the curing temperature of the ball is about 150° F.

4. The method of claim 1, wherein the spring force exerts about 600 pounds per square inch of pressure upon the parting line of the ball.

5. The method of claim 1, wherein the articulating dispensing module includes four independent mixing chambers, each having a dispensing nozzle.

6. The method of claim 1, wherein the core is formed from a thermoset polybutadiene, a reinforcing thermoset trans-polyisoprene, and a modified, non-ionic polyolefin.

7. The method of claim 1, wherein the dispensing nozzles provide cover layers selected from the group consisting polyurethanes, such as those prepared from polyols and diisocyanates or polyisocyanates, or polyureas, or polyurethane-urea hybrids, or copolymers comprising urethane or urea segments.

8. The method of claim 7, wherein the cover layers have a material hardness from about 30 to about 50 Shore D.

9. A method of casting an intermediate layer about a golf ball core, comprising the steps of:
providing a continuous motion conveyor system having a plurality of top and bottom single cavity mold halves, in continuous motion on the conveyor;
providing an articulating dispensing module comprised of multiple mixing chambers, each chamber having a dispensing nozzle;
pre-heating the mold halves to a temperature of about 200° F.;
dispensing metered shots of the intermediate material into the mold cavities while the mold halves are continually in motion and dispensing nozzle moves in tangent with one of the mold halves;
depositing by automatic robotic means a core into the bottom mold halve;
assembling the mold halves together to form a single cavity mold containing the core and intermediate layer;
compressing the intermediate material about the core by utilizing spring force and retainer plates to form a spherical golf ball;
curing the layered ball at a temperature of about 150° F.; and
disassembling the mold and automatically removing the layered ball.

10. The method of claim 9, wherein the articulating dispensing module includes four independent mixing chambers, each having a dispensing nozzle.

11. The method of claim 9, wherein the core is formed from a thermoset polybutadiene, a reinforcing thermoset trans-polyisoprene, and a modified non-ionic polyolefin.

12. The method of claim 9, wherein the articulating dispensing module includes four independent mixing chambers, each having a dispensing nozzle.

13. The method of claim 9, wherein the intermediate layers have a material hardness from about 50 to about 70 Shore D.
